(19) United States
(12) Patent Application Publication
(10) Pub. No.: US 2026/0187344 A1
(43) Pub. Date: Jul. 2, 2026

(54) INFORMATION GENERATION AND PUBLISHING METHOD, SYSTEM, DEVICE, STORAGE MEDIUM, AND PROGRAM PRODUCT

(71) Applicant: Hangzhou Alibaba International Internet Industry Co., Ltd., Hangzhou City (CN)

(72) Inventors: Huyu ZHANG, Hangzhou (CN); Zihua LI, Hangzhou (CN)

(21) Appl. No.: 19/423,630

(22) Filed: Dec. 17, 2025

(30) Foreign Application Priority Data
Dec. 31, 2024 (CN) 202411996601.2

(51) Int. Cl. G06F 40/143; G06F 40/279; G06V 10/74

(52) U.S. Cl. CPC G06F 40/143; G06F 40/279; G06V 10/761

(57) ABSTRACT

An information generation method comprises: obtaining object information of a first object, wherein the first object is a published object on a first website, and the object information of the first object originates from the first website; based on the object information of the first object, selecting, from second objects published on a second website, a similar object that is similar to the first object; based on a category to which the similar object belongs on the second website, determining a publication category to which the first object belongs on the second website; and based on the publication category and the object information of the first object, generating publication information required for publishing the first object on the second website.

### CROSS-REFERENCE TO RELATED APPLICATIONS

This application claims priority to Chinese Patent Application No. 202411996601.2, filed with the China National Intellectual Property Administration on Dec. 31, 2024, and entitled “Information Generation and Publishing Method, System, Device, Storage Medium, and Program Product,” which is incorporated herein by reference in its entirety.

### TECHNICAL FIELD

The present application relates to the field of computer technology, and in particular, to an information generation and publishing method, system, device, storage medium, and program product.

### BACKGROUND

With the continuous development of Internet technology, an increasing number of merchants are choosing to sell products on e-commerce websites (or e-commerce platforms). For merchants to sell products on an e-commerce website, they first need to publish the products on the e-commerce website. Product publishing is an important step in achieving online sales.

Currently, an increasing number of merchants are choosing to open stores on multiple different websites to expand their sales channels and thereby reach more consumers. While this strategy increases sales opportunities, it also brings operational challenges.

Although most of the products sold by merchants on different websites are the same, due to significant differences in product publishing among the various websites, merchants have to repeatedly perform multiple publishing operations (for example, multiple category selection operations), incurring extremely high product publishing costs. The repetitive operations not only consume the merchants'time and energy but also increase the risk of errors (for example, selecting the wrong category), which greatly affects the merchants'operational efficiency.

### SUMMARY

In view of the foregoing problems, the present application provides an information generation and publishing method, system, device, storage medium, and program product for solving the foregoing problems or at least partially solving the foregoing problems.

A first aspect of the present application provides a method for information generation, comprising:
obtaining object information of a first object, wherein the first object is a published object on a first website, and the object information of the first object originates from the first website;
based on the object information of the first object, selecting, from second objects published on a second website, a similar object that is similar to the first object;
based on a category to which the similar object belongs on the second website, determining a publication category to which the first object belongs on the second website;
based on the publication category and the object information of the first object, generating publication information required for publishing the first object on the second website.

A second aspect of the present application provides a method for information publishing, comprising:
obtaining object information of a first object, wherein the first object is a published object on a first website, and the object information of the first object originates from the first website;
based on the object information of the first object, selecting, from second objects published on a second website, a similar object that is similar to the first object;
based on a category to which the similar object belongs on the second website, determining a publication category to which the first object belongs on the second website;
based on the publication category and the object information of the first object, generating publication information required for publishing the first object on the second website;
based on the publication information, publishing the first object on the second website.

A third aspect of the present application provides a method for determining an information category, comprising:
obtaining object information of a first object, wherein the first object is a published object on a first website, and the object information of the first object originates from the first website;
based on the object information of the first object, selecting, from second objects published on a second website, a similar object that is similar to the first object;
based on a category to which the similar object belongs on the second website, determining a publication category to which the first object belongs on the second website.

A fourth aspect of the present application provides a method for displaying information, comprising:
displaying a first input box and a second input box;
receiving a target URL of a first object on a first website, input in the first input box, and a user's identity information registered on the first website, input in the second input box;
when the first object belongs to the user, displaying publication information required for publishing the first object on a second website, wherein the publication information is generated based on the object information of the first object, wherein the object information of the first object is determined based on a target webpage's webpage data, and the target webpage is the webpage identified by the target URL;
when the first object does not belong to the user, displaying a first prompt message, wherein the first prompt message is used for prompting that the first object does not belong to the user.

A fifth aspect of the present application provides an information processing system, comprising:
a terminal device, configured to send an information generation request to a server device, wherein the information generation request is used for requesting generation of publication information required for publishing a first object on a second website, and the first object is a published object on a first website;
a server device, configured to, in response to the information generation request, acquire object information of a first object, wherein the object information of the first object is from the first website; based on the object information of the first object, select, from second objects already published on the second website, a similar object that is similar to the first object; and based on a category to which the similar object belongs on the second website, determine a publication category to which the first object belongs on the second website.

A sixth aspect of the present application provides an electronic device. The electronic device comprises: a memory and a processor, wherein,

the memory is configured to store a program;

the processor is coupled to the memory and configured to execute the program stored in the memory to implement the method according to any one of the foregoing aspects.

A seventh aspect of the present application provides a computer-readable storage medium storing a computer program, wherein the computer program, when executed by a computer, is capable of implementing the method according to any one of the foregoing aspects.

An eighth aspect of the present application provides a computer program product, comprising a computer program, wherein the computer program, when executed by a processor, implements the method according to any one of the foregoing aspects.

In the technical solution provided by the embodiments of the present application, object information of a first object is acquired from a first website; based on the object information, a similar object similar to the first object is selected from second objects already published on a second website; based on the category to which the similar object belongs on the second website, the first object is classified, and a publication category to which the first object belongs on the second website is then determined. It can be seen that adopting this solution can automatically determine a suitable publication category for an object to be published, which improves the degree of automation and can greatly reduce the manual cost of information publishing.

In addition, publication information required for publishing the first object on the second website can be further automatically generated based on the publication category and the object information of the first object, which can further improve the degree of automation and can further reduce the manual cost of information publishing.

### BRIEF DESCRIPTION OF THE DRAWINGS

To more clearly illustrate the technical solutions in the embodiments of the present application or in the prior art, a brief introduction to the drawings required for describing the embodiments or the prior art will be provided below. It is apparent that the drawings in the following description are some embodiments of the present application. For a person of ordinary skill in the art, other drawings can also be obtained from these drawings without creative effort.

FIG. 1 is a schematic diagram of an information processing system provided in an embodiment of the present application;

FIG. 2a is an exemplary flowchart of an information generation method provided in an embodiment of the present application;

FIG. 2b is an exemplary flowchart of a publication category prediction method provided in an embodiment of the present application;

FIG. 3 is an exemplary diagram of a first interface provided in an embodiment of the present application;

FIG. 4 is a schematic diagram of a second interface provided by an embodiment of the present application;

FIG. 5 is an exemplary flowchart of an attribute information mapping method provided in an embodiment of the present application;

FIG. 6a is an exemplary flowchart of an information publishing method provided in an embodiment of the present application;

FIG. 6b is an exemplary flowchart of an information publishing method provided in an embodiment of the present application;

FIG. 7 is a service system architecture diagram on a server device side provided in an embodiment of the present application;

FIG. 8 is an exemplary flowchart of an information category determination method provided in an embodiment of the present application;

FIG. 9 is an exemplary flowchart of an information display method provided in an embodiment of the present application;

FIG. 10 is a structural block diagram of an electronic device provided in an embodiment of the present application.

### DETAIL DESCRIPTION OF THE EMBODIMENTS

In practical applications, the category-property-property value system (Category-Property-Value, CPV) of different websites is different. The differences are reflected in multiple aspects, such as different category structures (or category trees), different property names, and different property values. For example, a category structure is composed of multiple levels of categories, where the multiple levels include first-level categories and leaf categories. That is to say, the category to which the same product belongs is likely to be different on different websites. The property names and property values of different websites are also different.

Therefore, in practical applications, when a user wants to publish the same product on multiple websites, the user needs to manually select the category to which the product belongs on each website to complete the product publication, which is time-consuming and prone to incorrect selections. These problems are more prominent when publishing a large batch of products. Once the category to which the product belongs is selected incorrectly, it will not only affect the search and recommendation traffic of the product and reduce the sales volume of the product, but may also lead to a situation where incorrect products are recommended to consumers.

To solve or partially solve the above technical problems, in the technical solution provided by the embodiments of the present application, an on-site same-model object (i.e., a similar object) of an off-site object (i.e., a first object) is obtained through same-model matching, and the category to which the off-site object belongs on-site is determined based on the category to which the on-site same-model object belongs, thereby converting an off-site category expression into an on-site category expression. Adopting this solution can automatically determine a suitable publication category for an object to be published, which improves the degree of automation and can greatly reduce the manual cost of information publication, especially when a large amount of information needs to be published, the effect of reducing manual cost is more significant.

To enable persons skilled in the art to better understand the solution of the present application, the technical solutions in the embodiments of the present application will be clearly and completely described below with reference to the drawings in the embodiments of the present application. Apparently, the described embodiments are only some of the embodiments of the present application, rather than all of the embodiments. Based on the embodiments in the present application, all other embodiments obtained by persons of ordinary skill in the art without making creative efforts shall fall within the protection scope of the present application.

In addition, in some processes described in the specification, claims, and the above drawings of the present application, multiple operations that appear in a specific order are included, and these operations may not be executed in the order in which they appear herein or may be executed in parallel. The sequence numbers of the operations, such as 101, 102, etc., are only used to distinguish between different operations, and the sequence numbers themselves do not represent any execution order. In addition, these processes may include more or fewer operations, and these operations may be executed sequentially or in parallel. It should be noted that descriptions such as “first” and “second” herein are used to distinguish different messages, devices, modules, etc., do not represent a sequential order, and do not limit “first” and “second” to being different types.

It should be noted that the user information (including but not limited to user device information, user personal information, etc.) and data (including but not limited to data for analysis, stored data, displayed data, etc.) involved in the present application are all information and data that have been authorized by the user or fully authorized by all parties, and the collection, use, and processing of related data need to comply with relevant laws, regulations, and standards of relevant countries and regions, and corresponding operation portals are provided for users to choose to authorize or refuse.

First, the terms involved in the embodiments of the present application are explained. It can be understood that this explanation is for a clearer understanding of the embodiments of the present application and does not necessarily constitute a limitation on the embodiments of the present application.

Product Publishing: Refers to the process of creating and displaying product information on an e-commerce platform, including product name, description, price, images, etc., to attract consumers to purchase.

Category: That is, an object, for example, a classification of products, which refers to a collection of products having one or more common features, and can be divided into multi-level categories according to the division granularity, for example: Clothing—Men's Wear—Jacket, where Clothing is a first-level category, Men's Wear is a second-level category, and Jacket is a leaf category.

Attribute: Is a characteristic of an object, for example, a product, and an attribute value is the specific content of the attribute. For example: product attributes include color, size, collar type, sleeve type, etc., where the attribute values of the color attribute include red, pink, brown, etc.

Large Language Model (LLM): Refers to a natural language processing model based on deep learning, which is trained using neural networks and can automatically learn the rules and features of natural language, thereby implementing tasks such as language modeling, text generation, machine translation, and speech recognition. These models usually require large-scale data and computing resources for training, and are therefore called “large” language models.

Multimodal Large Model: A model obtained by jointly training on multimodal information such as text, images, video, and audio, that is, it refers to a large model that integrates processing capabilities for multiple different types of data under a unified framework, is capable of simultaneously processing data of multiple modalities, enabling a machine to understand the world more comprehensively and deeply.

Data Collection: Refers to the use of information acquisition technology to automatically collect product information from e-commerce websites, such as product name, description, price, images, reviews, etc., to facilitate data analysis, comparison, or market research.

Information Publishing: Refers to the process of creating and displaying information on a website; taking product publishing as an example, product publishing refers to the process of creating and displaying product information on an e-commerce platform, including product name, description, price, images, etc., to attract consumers to purchase.

Same-model Matching: Refers to identifying products that are of the same model as a given product by analyzing an object, for example, the title, images, attributes, etc. of the product.

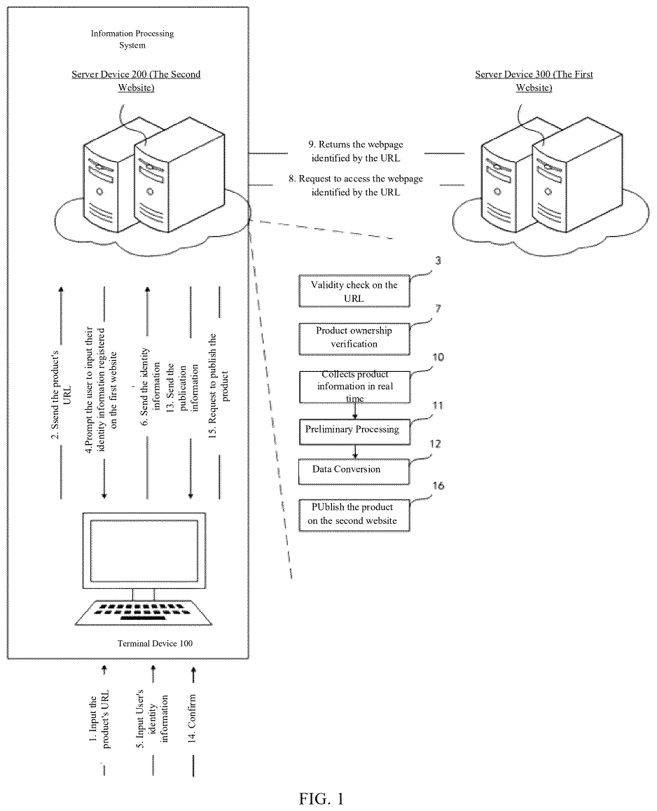

Before introducing the information category determination method, the information generation method, and the information publishing method provided in the embodiments of the present application, an information processing system for implementing these methods is introduced. As shown in FIG. 1, the information processing system may include: a terminal device 100 and a server device 200.

The terminal device 100 is configured to send an information generation request to the server device 200, where the information generation request is for requesting generation of publication information required for publishing a first object on a second website, and the first object is a published object on a first website.

The server device 200 is configured to, in response to the information generation request, acquire object information of a first object, where the object information of the first object originates from the first website; based on the object information of the first object, select, from second objects already published on the second website, a similar object that is similar to the first object; and based on a category to which the similar object belongs on the second website, determine a publication category to which the first object belongs on the second website.

In some implementations, the terminal device 100 may, in response to a user operation, send an information generation request to the server device 200. For example, the terminal device 100 may, in response to a user operation on an interface, send an information generation request to the server device 200.

In the technical solution provided by the embodiments of the present application, object information of a first object is acquired from a first website; based on the object information, a similar object similar to the first object is selected from second objects already published on a second website; based on the category to which the similar object belongs on the second website, the first object is classified, and a publication category to which the first object belongs on the second website is then determined. It can be seen that adopting this solution can automatically determine a suitable publication category for an object to be published, which improves the degree of automation and can greatly reduce the manual cost of information publishing.

In some embodiments, the server device 200 is further configured to generate, based on the publication category and the object information of the first object, publication information required for publishing the first object on the second website.

The technical solution provided by the embodiments of the present application further automatically generates publication information required for publishing the first object on the second website based on the publication category and the object information of the first object, which can further improve the degree of automation and further reduce the manual cost of information publication.

In some embodiments, the server device 200 is further configured to, based on the publication information, publish the first object on the second website.

Adopting the technical solution provided by the embodiments of the present application helps to improve the efficiency of information publication.

As an example, the above information processing system can be applied in the e-commerce field. Correspondingly, each of the above objects may be a product, which may specifically be, but is not limited to: clothing, home goods, shoes and boots, bags (such as handbags, backpacks, luggage, etc.), hats, gloves, accessories (such as bracelets, necklaces, wrist chains, earrings, headwear, etc.), electronic products (such as watches, mobile phones, notebook computers, tablet computers, etc.), bedding, and so on.

As an example, the above information processing system can be applied in the video-on-demand field. Correspondingly, each of the above objects may be a video, which may be, but is not limited to: a variety show video, an animation video, a movie, a TV series, a documentary, and so on.

The terminal device may be a smartphone, a tablet computer, a desktop computer, a smart wearable device, etc. The server device may be a single server, a server cluster, a virtual server deployed on a server, or a cloud, etc. As an example, the server device may be a server device of the second website.

The functional implementation details of each hardware component, such as the terminal device and the server device, in the information processing system will be described in detail in the following method embodiments.

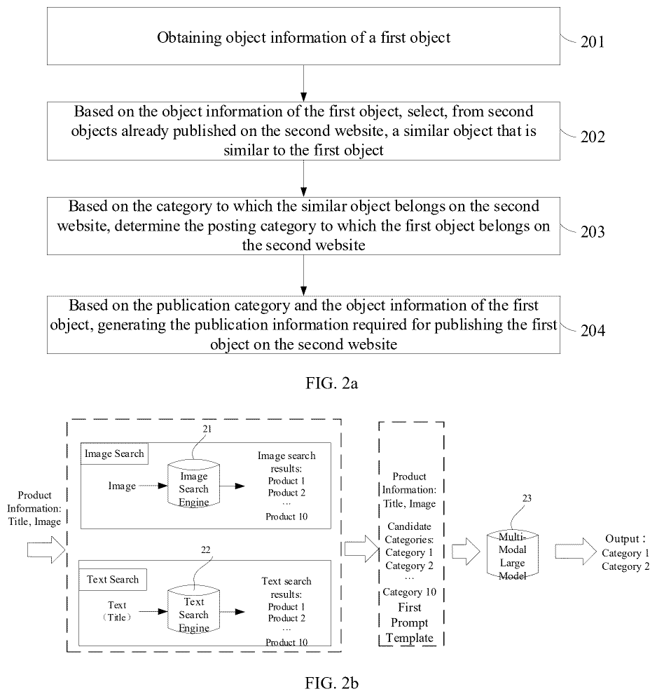

FIG. 2a is a schematic flowchart of an information generation method provided by an embodiment of the present application. In the method described in this embodiment, the execution subject of all steps may be the server device in the above system. Of course, if the terminal device has strong computing capabilities, the execution subject of the method of this embodiment may also be a client, or the client and the server may execute it collaboratively (i.e., some steps are executed by the client, and other steps are executed by the server). For ease of understanding, the following will take the server device as the execution subject as an example, to introduce the information generation method provided by the embodiment of the present application. As shown in FIG. 2a, the method may include the following steps:
201, acquiring object information of a first object.

Specifically, the first object is a published object on the first website.

The object information of the first object may include description information for describing the first object. For example, the description information may include multimodal description information, and the multimodal description information may include but is not limited to: text information, image information, and video information.

Specifically, the object information of the first object is sourced from the first website. The first object is a published object on the first website, and the object information of the first object is sourced from publication information published for the first object by the first website. The publication information published for the first object by the first website may include but is not limited to: the category to which the first object belongs on the first website, the original attribute information configured for the first object on the first website, and description information for describing the first object, where the description information may include multimodal description information, and the multimodal description information may include but is not limited to: text information, image information, and video information. It should be noted that the publication information in this document is used to describe a corresponding object.

In some embodiments, the object information of the first object may be sourced from webpage data of a webpage on the first website used for displaying the first object, where the page is a page for carrying the publication information of the first object. The webpage data may include: the category to which the first object belongs on the first website, the original attribute information configured for the first object on the first website (including original attribute names and attribute values of the original attribute names), and description information for describing the first object.

Taking the first website being an e-commerce platform and the first object being a product as an example, the product information of the product may be sourced from a webpage on the e-commerce platform used for displaying the product, for example, a product detail page. Webpage data can be obtained by performing data acquisition on the webpage, and the object information of the first object can be determined based on the webpage data.

In other embodiments, the object information of the first object may originate from a server device of the first website. For example, the server device 200 shown in FIG. 1 (which may be referred to as a server device of the second website) sends a data acquisition request to the server device of the first website, where the data acquisition request may carry an object identifier of the first object; the server device of the first website, in response to the data acquisition request, sends publication information related to the first object on the first website to the server device of the second website; and the server device of the second website determines the object information of the first object based on the publication information.
202. Based on the object information of the first object, select, from second objects already published on the second website, a similar object that is similar to the first object.

The number of second objects already published on the second website is one or more.

The first website and the second website are two different websites.

In an optional implementation, publication information published by the second website for second objects may be acquired, and based on a similarity between the object information of the first object and the publication information published by the second website for the second objects, a similar object similar to the first object is selected from one or more second objects already published on the second website.

Here, the publication information published by the second website for the second objects may include but is not limited to: a category to which a second object belongs on the second website, attribute information configured for the second object on the second website, and description information for describing the second object. The description information may include multi-modal description information, and the multi-modal description information may include but is not limited to: text information, image information, and video information.

In some embodiments, the object information of the first object includes multimodal description information of the first object. In the above 202, the step of “selecting, from second objects published on a second website, a similar object that is similar to the first object, based on the object information of the first object” can be implemented by the following steps:
2021, performing vectorization on the multimodal description information of the first object to obtain a vector for characterizing the first object.

Specifically, the multimodal description information of the first object includes: first text information and first image information.

Taking the first object being a product as an example, the first text information may include: a product title, product detail description text, etc., and the first image information may include: product images, for example: a main product image, a stock keeping unit (Stock Keeping Unit, SKU) image of the product, and a product detail image.

The first text information is vectorized to obtain a first text vector, and the first image information is vectorized to obtain a first image vector.

In some embodiments, the vector for characterizing the first object includes: the first text vector and the first image vector.
2022, acquiring a vector for characterizing the second object.

The multimodal description information of the second object includes: second text information and second image information.

In some embodiments, the vector for characterizing the second object may include: a second text information vector obtained by performing vectorization on the second text information and a second image vector obtained by performing vectorization on the second image information.

The vector for characterizing the second object may be obtained in advance through a vectorization operation and stored in a database, so that when it needs to be used subsequently, it can be directly acquired. This can save the time consumed for vectorization and help shorten the time required for information generation. Of course, if delay is not considered, the vector for characterizing the second object can also be directly obtained through a vectorization operation when it needs to be used subsequently.
2023, based on the vector for characterizing the first object and the vector for characterizing the second object, determining a similar object that is similar to the first object.

Based on the first text vector, the first image vector, the second text vector, and the second image vector, a similarity between the first object and the second object is determined, and the similar object is determined according to the similarity.

One or more of the following methods may be used to calculate the similarity between the first object and the second object:

### Method 1:

Based on the similarity between the first text vector and the second text vector, a first similarity between the first object and the second object is determined. Based on the similarity between the first image vector and the second image vector, a second similarity between the first object and the second object is determined. Based on the similarity between the first text vector and the second image vector, a third similarity between the first object and the second object is determined. Based on the similarity between the first image vector and the second text vector, a fourth similarity between the first object and the second object is determined.

Exemplarily, the similarity between two vectors can be a cosine similarity.

Exemplarily, the sum of the first similarity and the second similarity can be determined as a comprehensive similarity between the first object and the second object, and then a similar object is selected based on the comprehensive similarity. For example, objects with a comprehensive similarity greater than a preset threshold are determined to be similar objects. Of course, the top N similar objects can also be selected by sorting in descending order, where N is an integer greater than or equal to 1.

Exemplarily, first similar objects are selected based on the first similarity, second similar objects are selected based on the second similarity, and the first similar objects and the second similar objects are determined to be similar objects. The first similar objects and the second similar objects can be selected according to the same selection method in the above embodiments.

In a practical application, the first text information can be input into a text search engine, so that the text search engine determines the first similarity, sorts in descending order according to the first similarity, and thereby selects N1 first similar objects; the first image information is input into an image search engine, so that the image search engine determines the second similarity, sorts in descending order according to the second similarity, and thereby selects N2 second similar objects. Here, N1 and N2 are integers greater than or equal to 1, can be equal in value, for example, 10. The N1 first similar objects and the N2 second similar objects can be deduplicated to obtain the final similar objects. Taking the first object being a product as an example, as shown in FIG. 2b, the product information of the product includes a title and an image; the image is input into an image search engine 21, and the image search engine 21 outputs image search results; the text, i.e., the title, is input into a text search engine 22, to obtain text search results. The text search results and the image search results are deduplicated to obtain the final similar objects.

Exemplarily, the sum of the first similarity, the second similarity, the third similarity, and the fourth similarity is determined as a comprehensive similarity between the first object and the second object, and then similar objects are selected based on the comprehensive similarity. For the specific selection method, reference may be made to the corresponding content in the above embodiments.

### Method 2:

Concatenate the first text vector and the first image vector to obtain a first concatenated vector; concatenate the second text vector and the second image vector to obtain a second concatenated vector; determine the similarity between the first object and the second object based on the similarity between the first concatenated vector and the second concatenated vector; and then select similar objects based on the similarity. For the specific selection method, reference may be made to the corresponding content in the above embodiments.

In the embodiments of the present application, by vectorizing the multi-modal description information of the first object, a vector that can accurately represent the first object can be obtained, so that subsequently, based on vector similarity, similar objects similar to the first object can be found more accurately, which is conducive to accurately determining a publication category subsequently.
203, based on the category to which the similar object belongs on the second website, determine the publication category to which the first object belongs on the second website.

When there is one similar object, the category to which the similar object belongs on the second website can be determined as the publication category to which the first object belongs on the second website.

When there are multiple similar objects, one or more of the following methods can be used for determination:
Method one: The category to which the similar object most similar to the first object belongs on the second website can be determined as the publication category to which the first object belongs on the second website.
Method two: Count the categories to which each of the multiple similar objects belongs on the second website, and determine the category with the most occurrences as the publication category to which the first object belongs on the second website. For example: the multiple similar objects are A, B, C, D, and E, where the category to which A belongs on the second website is a1, the category to which B belongs on the second website is a1, the category to which C belongs on the second website is a1, the category to which D belongs on the second website is a2, and the category to which E belongs on the second website is a3; where the number of occurrences of a 1 is 3, the number of occurrences of a 2 is 1, and the number of occurrences of a 3 is 1; therefore, a 1, which has the most occurrences, is determined as the publication category to which the first object belongs on the second website.
Method 3: Use an LLM to filter.

Method 3 can be specifically implemented through the following steps:
2031: Determine the categories to which the multiple similar objects belong on the second website as multiple candidate categories.

Following the above example, a1, a2, and a3 can be determined as multiple candidate categories.

That is to say, the categories to which the multiple similar objects belong on the second website are not the same; it is necessary to take the categories to which the multiple similar objects belong on the second website as multiple candidate categories, i.e., multiple candidate categories.

2032: Generate a first prompt based on the object information of the first object and the multiple candidate categories.

Specifically, the first prompt is used to prompt the large language model to select the target category to which the first object belongs from the plurality of candidate categories.

In practical applications, to improve the efficiency of prompt construction, a first prompt template may be constructed in advance. A prompt template is a pre-designed prompt framework with a certain structure and format, which includes a fixed part and placeholders. The positions occupied by the placeholders in the template are positions to be filled, and by filling the placeholders, different prompts can be generated. The prompt template helps to improve the generation efficiency and standardization of prompts, making interaction with the LLM more convenient and effective.

In this way, the object information of the first object and the plurality of candidate categories are subsequently filled into the first prompt template, to obtain the first prompt.

In embodiments of the present application, utilizing the reasoning capability of an LLM to predict a publication category helps to improve the prediction accuracy of the publication category, thereby improving the reasonableness and usability of automatically generated publication information and reducing the operational cost for a user to post information.

To improve the accuracy of the LLM output, some examples may be additionally added to the first prompt to help the LLM better understand the data content of the current input, the operation/task to be performed, and the output format. Specifically, this may be implemented by the following steps:
S11. Based on object information of a plurality of the similar objects and categories to which the plurality of the similar objects belong on the second website, generating a plurality of first examples.

A first example may include multimodal description information of a similar object and the category to which the similar object belongs. For example, the format of the first example may be [multimodal description information of the similar object, the category to which the similar object belongs].
S12. Based on the object information of the first object, the plurality of candidate categories, and the plurality of first examples, generating a first prompt.

A first prompt is generated based on multimodal description information of the first object, the plurality of candidate categories, and the plurality of first examples.

For example, the multimodal description information of the first object, the plurality of candidate categories, and the plurality of first examples may be filled into a first prompt template to obtain a first prompt.
2033, the first prompt is input to the large language model to obtain the target category output by the large language model.

Specifically, a large language model can process multi-modal information, and therefore, can be called a multi-modal large model.

Taking the first object being a product as an example, as shown in FIG. 2b, a first prompt is constructed based on a first prompt template, a plurality of candidate categories, and product information, and the first prompt is input into a multi-modal large model 23, and the

### Large Model 23 Outputs Category 1 and Category 2.

It should be noted that the large language model may output one or more categories. When the large language model outputs multiple categories, the multiple categories may be sent to a user for the user to select a final category. The number of the multiple categories here is small, and the user can easily select from these few categories, which helps to improve the accuracy of category division.
2034. The target category is determined as the publication category to which the first object belongs on the second website.

When the target category output by the large language model is one, the target category output by the large language model may be determined as the publication category.

When the target categories output by the large language model are multiple, the target category selected by the user may be determined as the publication category.

In some embodiments, because the CPVs of different websites are different, the publication category is likely to be different from the category configured for the first object by the first website. For example: the publication category is: Apparel—Men's Clothing—Outerwear, and the category configured for the first object by the first website is: Men's Clothing—Tops—Jackets. The categories in the present application are multi-level categories, that is, they are composed of multiple categories of different levels.
204, based on the publication category and the object information of the first object, generating the publication information required for publishing the first object on the second website.

Optionally, the publication information required for publishing the first object on the second website may include: a publication category and multi-modal description information for describing the first object, for example: images, titles, etc.

In the technical solution provided by embodiments of the present application, object information of a first object is obtained from a first website; based on the object information, a similar object similar to the first object is selected from second objects already published on a second website; based on the category to which the similar object belongs on the second website, the first object is classified, thereby determining the publication category to which the first object belongs on the second website. It can be seen that using this solution can automatically determine a suitable publication category for an object to be published, which improves the degree of automation and can greatly reduce the manual cost of information publication. In addition, the publication information required for publishing the first object on the second website can be further automatically generated based on the publication category and the object information of the first object, which can further improve the degree of automation and further reduce the manual cost of information publication.

A process for obtaining object information of a first object is described below, where the acquisition process may include the following steps:
205, obtaining a target uniform resource identifier of the first object.

Uniform Resource Identifier (Uniform Resource Locator, URL) is a character string used to identify the name of an Internet resource.

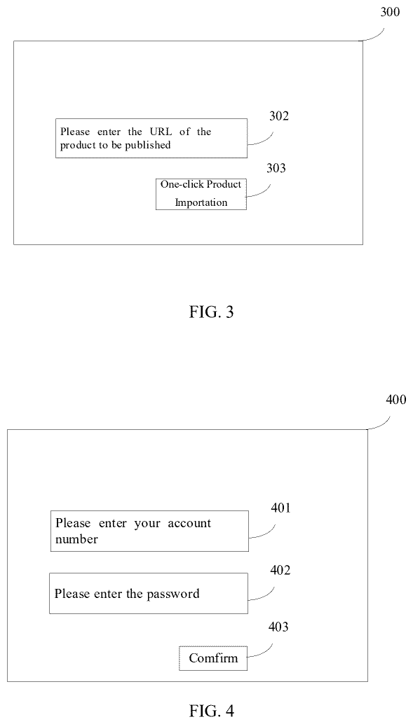

In an optional manner, the target URL is provided by a user. For example, as shown in FIG. 3, a terminal device displays a first interface 300, the first interface 300 displays a first input box 302 and a control “One-click Product Importation” 303, and in response to a trigger of the control 303 by the user, the target URL input by the user in the first input box is sent to a server device.

In another optional implementation, a target URL is generated based on website information of a first website provided by a user and an object ID of a first object provided by the user, where the object ID of the first object is assigned by the first website to the first object and is used to uniquely identify the first object on the first website. The website information of the first website may include a URL of the first website and/or a website name of the first website. It should be noted that, based on the website name of the first website, the URL of the first website can be obtained through a network or a pre-set correspondence between website names and URLs. The website information of the first website and the object ID of the first object may be provided by the user through an interface of a terminal device.

Taking an e-commerce platform as an example, the URL of a product is usually generated based on the URL of the e-commerce platform and the ID number of the product according to certain rules. Therefore, in an embodiment of the present application, the URL of the product can be generated according to the same rules based on the URL of the e-commerce platform and the product ID of the product.
206, according to the target URL, obtaining webpage data of a target webpage.

Specifically, the target webpage is identified by the target URL, the target webpage belongs to the first website, and the target webpage is used to display the first object.

According to the target URL of the first object on the first website, the target webpage identified by the target URL can be acquired; webpage data is obtained from the target webpage. Exemplarily, based on information acquisition technology and multi-terminal information acquisition technology, webpage data can be obtained from the webpage.

Specifically, the webpage data may include publication information published by the first website for the first object, for example: the category to which the first object belongs on the first website, the original attribute information configured for the first object on the first website, and descriptive information used to describe the first object, where the descriptive information may include multi-modal descriptive information, and the multi-modal descriptive information may include but is not limited to: text information, image information, and video information.

Taking the first object being a product as an example, based on information acquisition technology and multi-terminal information acquisition technology, it is possible to obtain from the webpage the product's open product information such as price, title, images, detailed content, category, and attribute information, to finally obtain the original product information of the product.
207, determining the object information of the first object according to the webpage data.

Optionally, the descriptive information (for example, multi-modal descriptive information) in the webpage data can be directly used as the object information of the first object.

In an embodiment of the present application, the technical solution of acquiring the object information of the first object via webpage acquisition has the advantage of being easy to implement.

In practical applications, when the languages used by the first website and the second website are different, preliminary processing may be performed on the webpage data, and the object information of the first object is determined based on the preliminarily processed webpage data. Exemplarily, the descriptive information used to describe the first object in the preliminarily processed webpage data is determined as the object information of the first object.

The preliminary processing may include: text translation and image translation. where, text translation refers to translating text into a target language, the target language is the type of language used by the second website, and image translation refers to identifying characters in an image, translating the characters into the target language, and replacing the original characters in the image at their positions. Taking the first object being a product as an example, the text may include information such as title, category, attribute information, and detailed description text.

When the first website and the second website are e-commerce platforms, the preliminary processing may further include: performing price conversion on the product price in the webpage data, for example: the first website uses prices in RMB, and the second website uses prices in USD, so the RMB price in the product information can be converted to a price in USD according to the current exchange rate.

Optionally, images in the first object information can also be stored in a content delivery network (Content Delivery Network, CDN) of the second website to facilitate subsequent information publishing. Taking a commodity as an example, images such as a main image and detail images of the commodity can be stored in the content delivery network CDN of the second website to facilitate subsequent commodity publishing.

The foregoing steps 205-207 are performed before the foregoing step 201, so that in subsequent steps, corresponding processing is performed based on the preliminarily processed webpage data (for example: object information, original attribute information).

Optionally, when the foregoing target URL is provided by a user, before performing the foregoing step 206, a validity check may be performed on the target URL according to a configuration file; when the validity check passes, according to the target URL, object information of a target object is obtained from the first website.

Specifically, the validity check may include but is not limited to: whether obtaining webpages of the website to which the URL belongs is supported (obtaining a webpage means obtaining webpage data from the webpage), and whether the format of the target URL is correct. In a practical application, URL formats of different websites can be written into a configuration file, and then, according to the configuration file, it is determined whether obtaining webpages of the first website is supported and whether the URL format input by the user is correct.

When the validity check fails, a prompt message may be sent to a terminal device. The prompt message is used to prompt that the URL input by the user is invalid. After sending the prompt message to the terminal device, the server device may also end the current process.

Through the validity check, it can be ensured that the user inputs a valid URL.

To avoid infringement risks in data acquisition and information use, in some embodiments, ownership may be verified. Specifically, in the foregoing 206, “obtaining webpage data of a target webpage according to the target URL” may be implemented by the following steps;
2061, obtaining from the user their identity information registered on the first website.

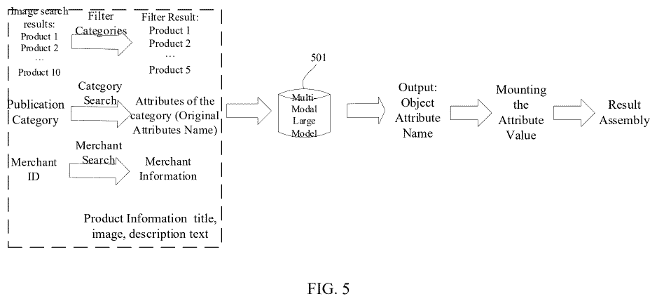

For example, as shown in FIG. 4, a terminal device displays a second interface 400, the second interface displays second input boxes (for example: 401 and 402) and a confirmation control 403, and in response to a trigger operation on the confirmation control 403 by the user, identity information input by the user in the second input boxes is sent to a server device.

For example, the second input box may include an input box 401 for inputting an account and an input box 402 for inputting a password.

The foregoing first interface 300 and second interface 400 may be the same interface or may be different interfaces. When the foregoing first interface 300 and second interface 400 are the same interface, the first input box and the second input box are displayed on the same interface.

For example, when the foregoing first interface 300 and second interface 400 are different interfaces, the terminal device, in response to a trigger operation by the user on the first interface 300 on the control 303, displays (for example, pops up) the second interface 400, and the second interface 400 displays second input boxes (for example: 401 and 402).
2062. Based on the identity information and the target URL, determine whether the first object belongs to the user.

In an optional implementation, in the foregoing step 2062, “based on the identity information and the target URL, determine whether the first object belongs to the user” may be implemented by the following steps:
S21. Based on the identity information, acquire a URL of at least one object belonging to the user on the first website.

Based on identity information registered by the user on the first website, a server device of the first website may be requested to provide a URL of at least one object belonging to the user on the first website. In this case, the server device of the first website may first verify the identity information, and after the verification is passed, return the URL of the at least one object belonging to the user on the first website to a server device of the second website.

It should be noted that, when the identity information verification fails, the server device of the first website may notify the server device of the second website, the server device of the second website may notify the terminal device, and the terminal device displays a prompt message indicating that the identity information verification has failed, and prompts the user to re-enter the identity information.

In practical applications, a server device of the second website may access an authorization component of a server device of the first website, verify the user's identity information by calling the authorization component, and after the verification is passed, acquire a URL of at least one object belonging to the user on the first website through an Application Programming Interface (Application Programming Interface, API) provided by the server device of the first website. Taking an e-commerce platform as an example, a URL of at least one product in the user's store may be acquired through the application programming interface.
S22. If the target URL exists in the URL of the at least one object, then it is determined that the first object belongs to the user.

When the target URL exists in the URL of the at least one object, it indicates that the first object belongs to the user.
S23, if the target URL does not exist in the URL of the at least one object, it is determined that the first object does not belong to the user.

When the target URL does not exist in the URL of at least one object, it indicates that the first object does not belong to the user.
2063, when the first object belongs to the user, according to the target URL, webpage data of a target webpage is obtained.

When the first object belongs to the user, a server device of a second website obtains object information of the first object from the first website according to the target URL.

When the first object does not belong to the user, a server device of a second website may send first prompt information to the user, where the first prompt information is used to prompt that the first object does not belong to the user.

In an embodiment of the present application, when obtaining object information of a first object from the first website, it is necessary to verify whether the first object belongs to the user, when the first object belongs to the user, the object information of the first object is obtained from the first website, when the first object does not belong to the user, the object information of the first object is not obtained from the first website. In this way, it is helpful to avoid infringement risks in data acquisition and commodity information use.

In a practical application, taking publishing a commodity as an example, when publishing a commodity, it is not only necessary to determine the category to which the commodity belongs, but also necessary to mount corresponding attribute information for the commodity under the category. However, for different websites, the category structures are different, and the attribute names (or called attribute names) mounted under the categories are also different. Therefore, a method for determining attribute information to be mounted for a first object will be introduced below. In some embodiments, in the foregoing 204, “generating, according to the publication category and the object information of the first object, publication information required for publishing the first object on the second website” may be implemented by the following steps:
2041. Based on the plurality of preset attribute names pre-configured by the second website for the publication category, determine the target attribute names required to be configured for the first object.

In practical applications, the second website assigns an attribute ID to each preset attribute name, used to uniquely identify the corresponding preset attribute name. Therefore, in the above 2041, the target attribute names required to be configured for the first object and their corresponding attribute IDs can be determined.

In an optional embodiment, the plurality of preset attribute names pre-configured by the second website for the publication category are determined as the target attribute names required to be configured for the first object.

In practical applications, for a certain category, the preset attribute names pre-configured by a website are relatively numerous, where some are mandatory attribute names, and some are optional attribute names.

In other optional embodiments, the mandatory attribute names pre-configured by the second website for the publication category can be determined as the target attribute names required to be configured for the first object.

In yet other optional embodiments, an LLM may be used to select the target attribute names required to be configured for the first object from the plurality of preset attribute names. Specifically, in the above step 2041, “Based on the plurality of preset attribute names pre-configured by the second website for the publication category, determine the target attribute names required to be configured for the first object” can be implemented using the following steps:
S31. Based on the object information of the first object, the original attribute names configured by the first website for the first object and the plurality of preset attribute names, generate a second prompt.

Specifically, the second prompt is used to prompt the large language model to select, from the plurality of preset attribute names, the target attribute names required to be configured for the first object.

A second prompt template may be obtained, and the object information of the first object, the first original attribute names configured by the website for the first object, and a plurality of preset attribute names are filled into the second prompt template, to obtain the second prompt.

To improve the accuracy of the LLM's output, some examples may be additionally added to the second prompt, which can help the LLM better understand the data content of the current input, the operations/tasks to be performed, and the output format. Specifically, this can be implemented using the following steps:
A. Determine a reference object from the similar objects.

Specifically, the reference object belongs to the target category.

Optionally, an object belonging to the target category among the similar objects can be determined as the reference object.

Optionally, the reference object can be an object belonging to the target category in the results obtained by searching based on the above-mentioned image search engine.
B. Generate a second example based on the object information of the reference object and the attribute names configured for the reference object by the second website.

The second example may include multimodal description information of the reference object and the attribute names configured for the reference object by the second website. Exemplarily, the format of the second example can be [multimodal description information of the reference object, original attribute names configured for the reference object].
C. Based on the object information of the first object, the plurality of preset attribute names, and the second example, generate a second prompt.

Fill the object information of the first object, the original attribute names configured for the first object by the first website, the second example, and the plurality of preset attribute names into a second prompt template, to obtain a second prompt.
S32. Input the second prompt to the large language model, to obtain the target attribute names output by the large language model.

Specifically, the number of target attribute names can be one or more.

In an embodiment of the present application, the reasoning capability of an LLM is utilized to complete a relatively accurate attribute name mapping (i.e., mapping from a source attribute name to a target attribute name).

2042, according to the source attribute information configured for the first object by the first website, determine an attribute value of the target attribute name.

Specifically, the source attribute information includes a source attribute name and a source attribute value corresponding to the source attribute name. The source attribute name and the source attribute value corresponding to the source attribute name are configured by the first website for the first object. For example, the source attribute name and the source attribute value corresponding to the source attribute name may be configured by the first website in response to a configuration operation by a user (e.g., a merchant) to which the first object belongs.

In an optional implementation, in the above step 2042, “determine the attribute value of the target attribute name according to the source attribute information configured for the first object by the first website” may be implemented by the following steps:
S41, acquire a plurality of optional values pre-configured by the second website for the target attribute name.

Taking an e-commerce platform as an example, assume that: the attribute names pre-configured by the first website for the category of Men's Clothing—Tops—Jackets are: Brand, Color, and Fabric; where, the plurality of optional values for Fabric are: combed cotton, mercerized cotton, wool, and cashmere; the attribute names pre-configured by the second website for the category of Apparel—Men's Clothing—Outerwear are Brand, Color, Material, etc., where the plurality of optional values for Material include: cotton, wool, and spandex.
S42, determine a reference attribute name that matches the target attribute name from the source attribute names.

Specifically, there are a plurality of source attribute names. In an optional method, a vectorization may be performed on the plurality of source attribute names, to obtain one or more text vectors of the source attribute names; a vectorization is performed on the target attribute name to obtain a text vector of the target attribute name; a vector similarity between the text vector of the target attribute name and the text vector of each of the plurality of source attribute names is calculated, and the source attribute name with the highest vector similarity is determined as the reference attribute name.

Continuing with the above example, product A belongs to the category of Men's Clothing—Tops—Jackets on the first website; the first website has configured a plurality of source attribute names for product A, which are in order: Brand, Color, and Fabric (main fabric); the publication category to which product A belongs on the second website is: Apparel—Men's Clothing—Outerwear; the target attribute name that needs to be configured for the first object to be published on the second website is Material (material); among the three source attribute names of Brand, Color, and Fabric, the one that best matches Material is Fabric; therefore, Fabric is determined as the reference attribute name.
S43, according to the similarity between the source attribute value corresponding to the reference attribute name and the plurality of optional values, determine, from the plurality of optional values, a target attribute value corresponding to the target attribute name.

The original attribute value and the multiple optional values can be represented as vectors, and then based on vector similarity, the optional value with the highest similarity is selected from the multiple optional values as the target attribute value corresponding to the target attribute name.

Continuing with the previous example, on the first website, the original attribute value corresponding to the attribute name “fabric” for product A is “mercerized cotton”; “mercerized cotton” is most similar to “cotton” among the multiple optional values of “cotton”, “wool”, and “spandex” corresponding to the attribute name “material” on the second website, and therefore, “cotton” can be determined as the target attribute value for “material”.

In other words, the original attribute value corresponding to the reference attribute name and the target attribute value corresponding to the target attribute name are different.

In practical applications, attributes can be divided into required items and optional items, therefore, when the target attribute name is a required attribute name, the optional value most similar to the original attribute value is used as the target attribute value corresponding to the target attribute name. When the target attribute name is an optional item, the optional value most similar to the original attribute value is determined; when the similarity between this optional value and the original attribute value is greater than a preset threshold, this optional value is used as the target attribute value corresponding to the target attribute name; otherwise, the target attribute value corresponding to the target attribute name is set to null, that is, no attribute value is assigned to the target attribute name.

In practical applications, the second website assigns a value ID to each optional value, therefore, the above step S43 can determine the target attribute value corresponding to the target attribute name and the value ID of the target attribute value.

In an embodiment of the present application, the original attribute value of the original attribute name is not simply used as the attribute value of the target attribute name, but instead, the optional value that best matches the original attribute value among the multiple optional values configured by the second website for the target attribute name is used as the attribute value of the target attribute name, which helps to improve the mapping accuracy of attribute values.
2043, based on the publication category, the target attribute name, and the target attribute value corresponding to the target attribute name, generating publication information required for publishing the first object on the second website.

The publication information may include: the publication category, the target attribute name, and the target attribute value corresponding to the target attribute name. Optionally, the publication information may also include: descriptive information for describing the first object, for example: a title, images, etc.

For example, as shown in FIG. 5, category filtering is performed on the image search results of the image search engine 21 in FIG. 2b above, to filter out products belonging to a publication category from the image search results; a second example is generated according to the product information of the filtered-out products and attribute names configured for the products by a second network; according to the publication category, a plurality of preset attribute names configured for the publication category by a second website are queried, where the plurality of preset attribute names may be referred to as category attributes of the publication category, and where the plurality of preset attribute names are divided into two types: required attribute names and optional attribute names (e.g., sales attributes); merchant information is queried according to a merchant ID of a merchant (i.e., a merchant who needs to publish the product on the second website), where the merchant information may include the merchant's main business content, name, and other information; a second prompt word may be generated according to the product information (e.g., title, image, description text, etc.), the category attributes of the publication category, the second example, and the merchant information, and the second prompt word is input into a multi-modal large model 501, to obtain target attribute names output by the large model 501. According to preset rules and text similarity, target attribute values are mounted for the target attribute names, where the preset rules refer to: attribute management rules of the second website, for example, if divided into required attribute names, then this attribute name must have an attribute value, and when mounting the attribute value, it is ensured that a value is mounted under this attribute name, whereas for sales attributes such as size, it may not be necessary to ensure that there is always a value. In some cases, there may be a plurality of target attribute names. Finally, result assembly/summary is performed to obtain a required attribute list [{attribute name, value, attribute ID}] and a sales attribute list [{attribute name, value, attribute ID}].

When the second website is an e-commerce website, after obtaining target attribute information (i.e., the target attribute names and target attribute values corresponding to the target attribute names), SKU information can be generated based on this. The SKU information may include but is not limited to the target attribute information, price information, weight information, etc. In addition, recommended logistics routes can also be generated based on information such as weight and size.

In summary, by using same-model matching to obtain on-site equivalents of off-site products, combined with a large model, the precision and recall rate of category prediction is improved, an attribute mapping function is implemented, converting the expression of an off-site category system into the expression of an on-site category system, and solving the problems of inaccurate categories and the inability to fill in original product attributes. In addition, based on artificial intelligence algorithms, such as an LLM, the original title and description of a product are optimized, selling points, logistics information, price information, etc., are automatically generated, and based on a visual model, images are translated and generated to produce images that conform to on-site standards, so that merchants can publish products without modification.

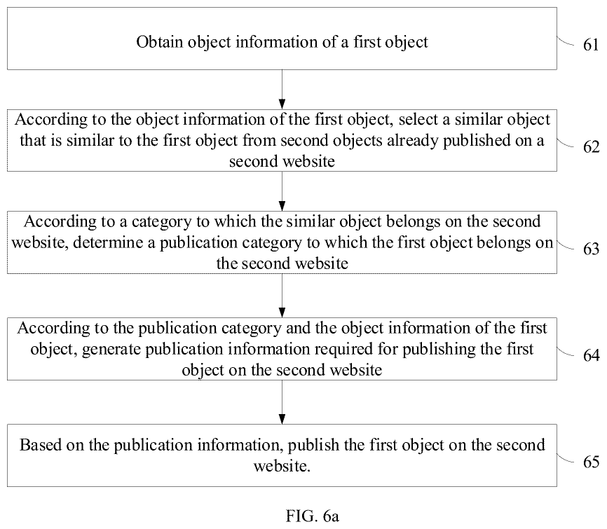

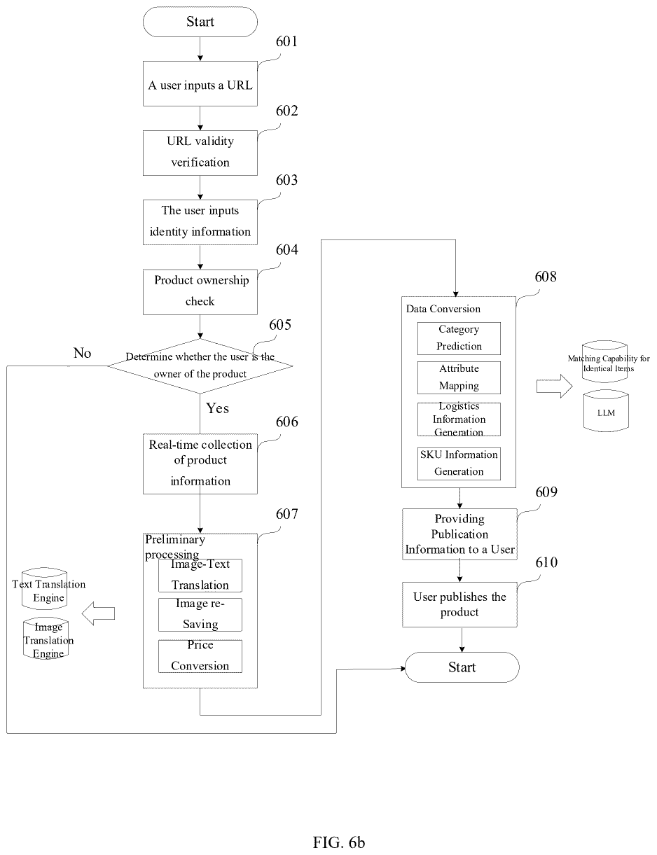

FIG. 6a is a schematic flowchart of an information publishing method provided in an embodiment of the present application. The execution subject of all steps in the method described in this embodiment may be the server device in the above system. Of course, if a terminal device has strong computing capabilities, the execution subject of the method of this embodiment may also be a client, or the client and the server may execute collaboratively (i.e., some steps are executed by the client, and other steps are executed by the server). As shown in FIG. 6a, the method may include the following steps:
61, obtain object information of a first object.

Specifically, the first object is a published object on a first website, and the object information of the first object originates from the first website.
62, according to the object information of the first object, a similar object that is similar to the first object are selected from second objects already published on a second website.
63, according to a category to which the similar object belongs on the second website, determine a publication category to which the first object belongs on the second website.
64, according to the publication category and the object information of the first object, generate publication information required for publishing the first object on the second website.
65, based on the publication information, publish the first object on the second website.

In an optional implementation, the first object may be published directly based on the publication information.

It should be noted that: for details of the various steps in the method provided in the embodiments of the present application that are not described in full, reference may be made to the corresponding content in the above-described embodiments, and details are not described herein again. Furthermore, in addition to the steps described above, the method provided in the embodiments of the present application may also include some or all of the other steps from the above-described embodiments; for details, reference may be made to the corresponding content in the above-described embodiments, which will not be described again here.

Taking the first object being a product as an example below, in conjunction with FIG. 6b, the technical solution provided in the embodiment of the present application is described by way of example. As shown in FIG. 6b, the method may include the following steps:
601, a user inputs a URL.

A user (i.e., a merchant) may, through a terminal device provided, as shown in FIG. 3, on the first interface 300, via the first input box 302, input a URL of a product, and click a “One-click Product Importation” control 303 on the first interface 300, and the terminal device sends the URL of the product to a server device of a second website.
602, URL validity verification.

The server device of the second website uses a URL format configuration file to perform a validity check on the product URL, and after the check is successful, notifies the terminal device for the terminal device to display the second interface 400 shown in FIG. 4.

If the check fails, the terminal device is notified, for the terminal device to prompt the user about an input error and to re-enter.
603, the user inputs identity information.

The user may input user identity information via the second input box 401 on the second interface 400, and click the confirmation control 403 on the second interface 400, and the terminal device sends the user's identity information to the server device of the second website.
604, product ownership check.

The server device of the second website calls an authorization component provided by the first website, to check whether the product belongs to the user.
605, determine whether the user is the owner of the product.

According to the check result, it is determined whether the user is the owner of the product. If the product belongs to the user, then step 606 is executed, otherwise, the entire process is ended.
606, real-time collection of product information.

The webpage of the product is obtained according to the URL of the product, data acquisition is performed on the webpage to obtain webpage data, where the webpage data includes product information.
607, perform data processing on the collected data (i.e., the preliminary processing mentioned above).

Data processing involves: image-text translation, image re-saving, and price conversion, etc. For specific implementations, reference may be made to the corresponding content in the above embodiments, which will not be repeated here.
608, data conversion.

Data conversion comprises: category prediction (i.e., determination of the publication category), attribute mapping (i.e., determination of the target attribute name and its attribute value), currency conversion (for example: converting RMB to USD), logistics information generation, and SKU information generation. For specific implementation, reference may be made to the corresponding content in the above embodiments, which will not be described in detail here again.

Based on the data conversion result, publication information required for publishing the product on the second website is generated.
609, providing publication information to a user.

The publication information may be sent to a terminal device in the form of a product form, the terminal device displays the product form on a third interface, for a user to modify and confirm.
610, a user publishes the product.

In response to a trigger operation by a user on a publication control on the third interface, the terminal device sends a publication request to a server device of the second website, and the server device of the second website publishes the product on the second website based on the publication information confirmed by the user.

In an actual application, after a user enters the URL of a product to be published off site (on the first website) into an input box displayed on a terminal device, the user clicks a “one-click product importation” control displayed on the terminal device. In response to the user's click operation on the control, the terminal device sends the URL of the product to be published off site to an on-site server device (the second website). The on-site server device performs a validity check on the URL. After the check is successful, the server device notifies the terminal device to cause the terminal device to display an authorization interface (as shown in FIG. 4), allowing the user to enter, on the authorization interface, the account and password that the user registered off site. After the on-site server device receives the account and password sent from the terminal device, it verifies whether the product to be published belongs to the user by calling an authorization component provided off site. When the product to be published belongs to the user, the on-site server device acquires webpage data based on the URL, performs data processing and data conversion on the webpage data to generate publication information required for publishing the product on site, and sends the publication information to the user to be confirmed and published.

The technical solution provided by the embodiments of the present application solves the difficult problem of how to convert the off-site product system expression into the on-site product system, where category prediction and attribute mapping are key. First, based on the product information, the on-site belonging category of the off-site product is predicted, and based on the product information and the predicted category, the original attributes of the off-site product are mapped to attributes under the on-site attribute system.

The technical solution provided by the embodiments of the present application acquires complete original product information based on multi-terminal collection and information acquisition technologies, which is beneficial for improving the success rate and completeness of original product information collection. Based on official category attribute data, combined with same-model matching and large model prediction, the obtained categories and attributes are more accurate and of higher quality. The solution can parse and fill complex SKU information, and a user can implement one-click product publication based on the generated information. By accessing OAuth authorization to verify product ownership, a user can only publish their own products, which avoids the risk of infringement in data acquisition and product information use.

The technical solution provided by embodiments of the present application, based on operations using a large language model such as real-time acquisition of a merchant's products on other platforms, category prediction, and attribute mapping, enables merchants to quickly perform one-click product importation from off site to on site, improving the efficiency and quality of merchant product publications, driving growth in the scale of high-quality supply on the website, and having strong practical value. One-click product importation refers to an operation where a user inputs a product URL to publish a product, which is already published off site, to on site with one click. For example, as shown in FIG. 3, after a user inputs a product URL, by clicking the “One-Click Product Importation” control 302 on the first interface 300, the product publishing can be completed.

Still taking the first object being a product as an example, the interaction process between the various devices in FIG. 1 is introduced in detail as follows:
1. A user inputs the product's URL via the terminal device 100.
2. The terminal device 100 sends the product's URL to the server device 200 of the second website.
3. The server device 200 performs a validity check on the URL.

After the validation passes, execute step 4.
4. The server device 200 notifies the terminal device 100 to prompt the user to input their identity information registered on the first website.
5. The user via the terminal device 100 inputs identity information.
6. The terminal device 100 to the server device of the second website 200 sends identity information.
7. The server device of the second website 200 performs product ownership verification.

When it is verified that the product belongs to the user, step 8 is executed.
8. The server device 200 of the second website requests to access the webpage identified by the URL from the server device 300 of the first website.
9. The server device 300 of the first website returns the webpage identified by the URL to the server device 200 of the second website.
10. The server device of the second website 200, by acquiring the webpage, collects product information in real time.
11. The server device of the second website 200 performs preliminary processing.
12. The server device of the second website 200 performs data conversion.

Through step 11 and step 12, the publication information required for publishing the product on the second website is obtained.
13. The server device of the second website 200 sends the publication information to the terminal device 100.
14. The user, via the terminal device 100, confirms the publication information.
15, the terminal device 100 requests the server device of the second website 200 to publish a product.
16, the server device of the second website 200 publishes a product on the second website.

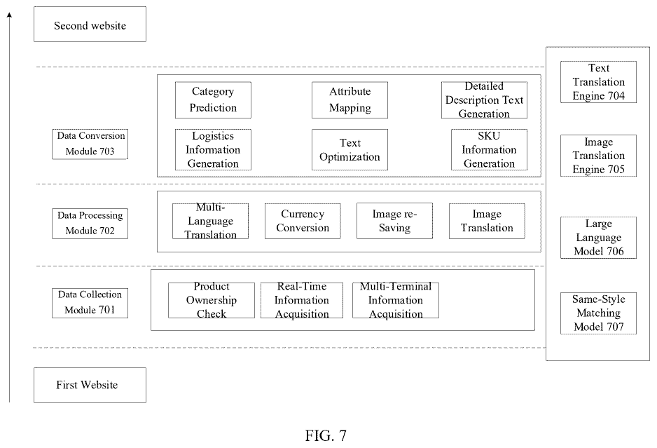

Taking a product as an example of the first object, FIG. 7 is a schematic diagram of a service architecture on a server device side provided in an embodiment of the present application. As shown in FIG. 7, the server device comprises a data collection module 701, a data processing module 702, and a data conversion module 703. The data collection module 701 is used to implement functions such as product ownership verification, real-time information acquisition, and multi-terminal information acquisition, and specifically comprises: collecting product data from e-commerce websites, where before collection, product ownership verification needs to be performed to verify whether the collected product belongs to the user, and collection will only continue after verification passes; solving data acquisition problems through technologies such as CAPTCHA recognition, proxies, and cookie planting; and implementing multi-terminal collection on the APP (Application) end, mobile end, and web end to collect the target product and obtain original product information. The data processing module 702 is used to implement functions such as multi-language translation, currency conversion, image re-storage, and image translation, and specifically comprises: preliminarily processing product information; text translation: translating non-English text such as titles and descriptions in the product information into English; currency conversion: converting the currency to US dollars; image re-storage: where since the collected product images are on the CDN of the first website and cannot be used directly when publishing the product, the images need to be downloaded and then uploaded to the CDN of the second website, including the main product image, SKU images, and product detail images. The data conversion module 703 is used to implement functions such as category prediction, attribute mapping, detailed description text generation, logistics information generation, and text optimization and SKU information generation, and specifically comprises: converting an off-site (i.e., the first website) product model to an on-site (i.e., the second website) product publishing model, where product information from other e-commerce platforms cannot be used directly on this e-commerce platform due to issues such as inconsistent price types, inconsistent category structures, and unmappable attributes, and leveraging basic capabilities such as same-model matching and large models to perform operations such as category prediction, attribute mapping, and detailed description generation to convert to the on-site product model and fill out forms, the user can publish on-site with one click. Specifically, the detailed description text generation can be performed by using a large language model based on multi-modal information of the product, and the text optimization can include title optimization, for example: inputting the product title and multi-modal information into the large language model, so that the large language model optimizes the title in combination with the multi-modal information.

Specifically, some functions of the data processing module 702 can be implemented by calling a text translation engine 704 and an image translation engine 705, and some functions of the data conversion module 703 can be implemented by calling a large language model 706 and a same-model matching model 707.

For the specific implementation and specific interaction process of each module and each engine in FIG. 7, reference can be made to the corresponding content in the above embodiments, which will not be described in detail herein.

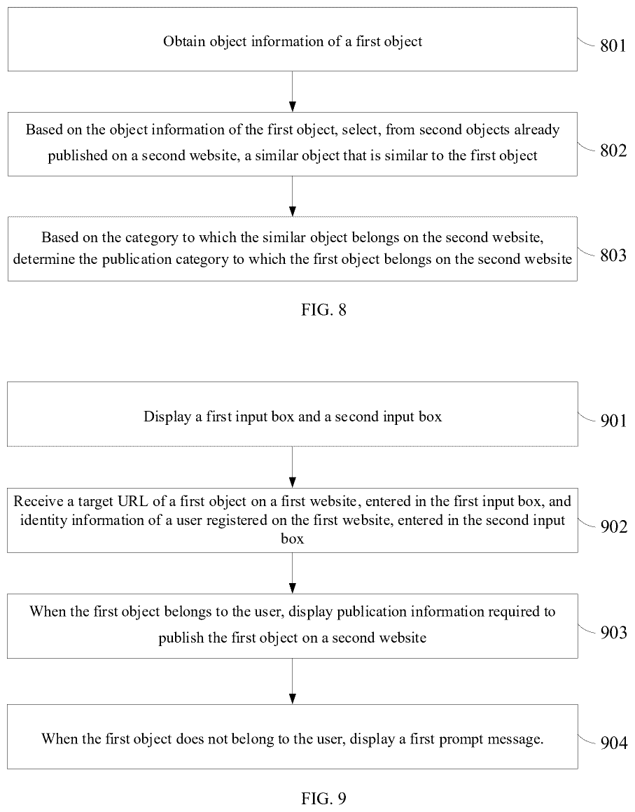

FIG. 8 is a schematic flowchart of a method for determining an information category provided in an embodiment of the present application. The execution entity of all steps in the method described in this embodiment may be the server device in the above system. Of course, if the terminal device has strong computing capabilities, the execution entity of the method of this embodiment may also be a client, or the client and the server may execute collaboratively (i.e., some steps are executed by the client, and other steps are executed by the server). As shown in FIG. 8, the method may comprise the following steps:
801, Acquire object information of a first object.

Specifically, the first object is a published object on a first website, and the object information of the first object originates from the first website.
802, based on the object information of the first object, select, from second objects already published on a second website, a similar object that is similar to the first object.
803, based on the category to which the similar object belongs on the second website, determine the publication category to which the first object belongs on the second website.

It should be noted that: for details of the various steps in the method provided in the embodiments of the present application that are not described in full, reference may be made to the corresponding content in the above-described embodiments, and details are not described herein again. Furthermore, in addition to the steps described above, the method provided in the embodiments of the present application may also include some or all of the other steps from the above-described embodiments; for details, reference may be made to the corresponding content in the above-described embodiments, which will not be described again here.

FIG. 9 is a schematic flowchart of a method for displaying information provided in an embodiment of the present application. The execution entity of all steps in the method described in this embodiment may be the server device in the above system. Of course, if the terminal device has strong computing capabilities, the execution entity of the method of this embodiment may also be a client, or the client and the server may execute collaboratively (i.e., some steps are executed by the client, and other steps are executed by the server). As shown in FIG. 9, the method may comprise the following steps:
901, display a first input box and a second input box.
902, receive a target URL of a first object on a first website, entered in the first input box, and identity information of a user registered on the first website, entered in the second input box;
903, when the first object belongs to the user, display publication information required to publish the first object on a second website.

Specifically, the publication information is generated based on object information of the first object, and the object information of the first object is determined based on the target webpage's webpage data, where the target webpage is the webpage identified by the target URL.
904, when the first object does not belong to the user, display a first prompt message.

Specifically, the first prompt message is used to indicate that the first object does not belong to the user.

In the above 901, the first input box and the second input box can be displayed in the same interface, or can be displayed in different interfaces. In an optional implementation, the above 901 may include: displaying a first interface, where the first interface includes a first input box; in response to receiving the target URL entered in the first input box, displaying a second interface, where the second interface includes the second input box.

It should be noted that: for details of the various steps in the method provided in the embodiments of the present application that are not described in full, reference may be made to the corresponding content in the above-described embodiments, and details are not described herein again. Furthermore, in addition to the steps described above, the method provided in the embodiments of the present application may also include some or all of the other steps from the above-described embodiments; for details, reference may be made to the corresponding content in the above-described embodiments, which will not be described again here.

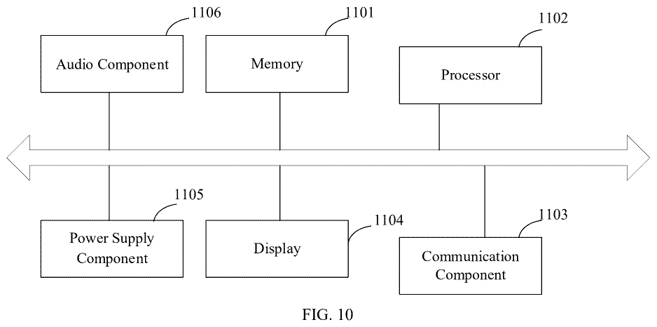

FIG. 10 shows a schematic structural diagram of an electronic device provided by an embodiment of the present application. As shown in FIG. 10, the electronic device includes a memory 1101 and a processor 1102. The memory 1101 may be configured to store various other data to support operations on the electronic device. Examples of these data include instructions for any application or method operated on the electronic device. The memory 1101 may be implemented by any type of volatile or non-volatile storage device or a combination thereof, such as a static random access memory (Static Random Access Memory, SRAM), an electrically erasable programmable read-only memory (Electrically Erasable Programmable read only memory), EEPROM), an erasable programmable read-only memory (Electrical Programmable Read Only Memory, EPROM), a programmable read-only memory (Programmable Read Only Memory, PROM), a read-only memory (Read Only Memory, ROM), a magnetic memory, a flash memory, a magnetic disk, or an optical disc.

The memory 1101 is for storing a program.

The processor 1102, coupled to the memory 1101, is for executing the program stored in the memory 1101 to implement the methods provided by the above method embodiments.

Further, as shown in FIG. 10, the electronic device further includes: a communication component 1103, a display 1104, a power supply component 1105, an audio component 1106, and other components. FIG. 10 only schematically shows some components, which does not mean that the electronic device only includes the components shown in FIG. 10.

Correspondingly, an embodiment of the present application also provides a computer-readable storage medium storing a computer program, where the computer program, when executed by a computer, is capable of implementing the steps or functions of the methods provided by the above method embodiments.

An embodiment of the present application also provides a computer program product, comprising a computer program, where the computer program, when executed by a processor, is capable of implementing the steps or functions of the methods provided by the above method embodiments.

The device embodiments described above are merely illustrative, where the units described as separate components may or may not be physically separate, and the components displayed as units may or may not be physical units; that is, they may be located in one place or distributed across multiple network units. Some or all of the modules may be selected according to actual needs to achieve the objectives of the solutions of this embodiment. A person of ordinary skill in the art can understand and implement the solutions without creative effort.

From the description of the above embodiments, a person skilled in the art can clearly understand that each embodiment can be implemented by means of software plus a necessary general-purpose hardware platform, and of course, can also be implemented by hardware. Based on such an understanding, the essence of the above technical solutions, or the part that contributes to the prior art, can be embodied in the form of a software product. The computer software product can be stored in a computer-readable storage medium, such as ROM (Read Only Memory, read-only memory)/RAM (Random Access Memory, random access memory), a magnetic disk, an optical disc, etc., and includes several instructions for causing a computer device (which may be a personal computer, a server, or a network device, etc.) to execute the methods described in various embodiments or certain parts of the embodiments.

Finally, it should be noted that: the above embodiments are merely used to illustrate the technical solutions of the present application, and not to limit them; although the present application has been described in detail with reference to the foregoing embodiments, a person of ordinary skill in the art should understand that: they can still modify the technical solutions described in the foregoing embodiments, or make equivalent replacements for some of the technical features; and these modifications or replacements do not cause the essence of the corresponding technical solutions to depart from the spirit and scope of the technical solutions of the embodiments of the present application.

1. An information generation method, comprising:
obtaining object information of a first object, wherein the first object is a published object on a first website, and the object information of the first object originates from the first website;
based on the object information of the first object, selecting, from second objects published on a second website, a similar object that is similar to the first object;
based on category to which the similar object belongs on the second website, determining a publication category to which the first object belongs on the second website;
based on the publication category and the object information of the first object, generating publication information required for publishing the first object on the second website.

2. The method of claim 1, wherein:
the object information of the first object comprises multimodal description information of the first object;
the selecting the similar object that is similar to the first object from second objects published on a second website, based on the object information of the first object, comprises:
vectorizing the multimodal description information of the first object to obtain a vector for characterizing the first object;
obtaining vectors for characterizing the second objects;
based on the vector for characterizing the first object and the vectors for characterizing the second objects, determining the similar object similar to the first object.

3. The method of claim 2, wherein the multimodal description information of the first object comprises: first text information and first image information; the vector for characterizing the first object comprises: a first text vector obtained by vectorizing the first text information and a first image vector obtained by vectorizing the first image information; the multimodal description information of each of the second objects comprises: second text information and second image information, and the vector for characterizing the second object comprises: a second text vector obtained by vectorizing the second text information and a second image vector obtained by vectorizing the second image information; and
the determining the similar object similar to the first object, based on the vector for characterizing the first object and the vectors for characterizing the second objects, comprises:
based on a similarity between the first text vector and the second text vectors, determining a first similarity between the first object and the second objects;
based on a similarity between the first image vector and the second image vectors, determining a second similarity between the first object and the second objects;
based on the first similarity and the second similarity, determining the similar object.

4. The method of claim 1, wherein a number of the similar object is plural; and the determining the publication category to which the first object belongs on the second website, based on the categories to which the similar objects belong on the second website, comprises:
determining the categories to which the plurality of similar objects belong on the second website as a plurality of candidate categories;
based on the object information of the first object and the plurality of candidate categories, generating a first prompt, wherein the first prompt is used for prompting a large language model to select, from the plurality of candidate categories, a target category to which the first object belongs;
inputting the first prompt to the large language model to obtain the target category by the large language model;
determining the target category as the publication category to which the first object belongs on the second website.

5. The method of claim 4, wherein the generating the first prompt, based on the object information of the first object and the plurality of candidate categories, comprises:
based on object information of the plurality of similar objects and categories to which the plurality of similar objects belong on the second website, generating a plurality of first examples;
based on the object information of the first object, the plurality of candidate categories, and the plurality of first examples, generating the first prompt.

6. The method of claim 1, wherein the generating, based on the publication category and the object information of the first object, publication information required for publishing the first object on the second website, comprises:
based on a plurality of preset attribute names pre-configured by the second website for the publication category, determining target attribute names required to be configured for the first object;
based on original attribute information configured by the first website for the first object, determining target attribute values corresponding to the target attribute names, wherein the original attribute information comprises original attribute names and original attribute values corresponding to the original attribute names;
based on the publication category, the target attribute names, and the target attribute values corresponding to the target attribute names, generating publication information required for publishing the first object on the second website.

7. The method of claim 6, wherein the determining the target attribute values corresponding to the target attribute names, based on the original attribute information configured by the first website for the first object, comprises:
obtaining a plurality of optional values pre-configured by the second website for the target attribute names;
determining, from the original attribute names, a reference attribute name that matches a target attribute name;
based on a similarity between an attribute value corresponding to the reference attribute name and the plurality of optional values, from the plurality of optional values, determining the corresponding target attribute value for the target attribute name.

8. The method of claim 6, wherein the determining the target attribute names required to be configured for the first object, based on a plurality of preset attribute names pre-configured by the second website for the publication category, comprises:
based on the object information of the first object, original attribute names configured by the first website for the first object, and the plurality of preset attribute names, generating a second prompt, wherein the second prompt is used for prompting a large language model to select, from the plurality of preset attribute names, the target attribute names required to be configured for the first object;
inputting the second prompt to the large language model, to obtain the target attribute names output by the large language model.

9. The method of claim 8, wherein the generating the second prompt, based on the object information of the first object and the plurality of preset attribute names, comprises:
determining a reference object from the similar object, where the reference object belongs to the target category;
based on object information of the reference object and attribute names configured by the second website for the reference object, generating a second example;
based on the object information of the first object, the plurality of preset attribute names, and the second example, generating the second prompt.

10. The method of claim 1, wherein the method further comprises:
obtaining a target Uniform Resource Locator (URL) of the first object;
obtaining webpage data of a target webpage according to the target URL; wherein the target webpage is identified by the target URL, the target webpage belongs to the first website, and the target webpage is used to display the first object;
determining object information of the first object according to the webpage data.

11. The method according to claim 1, wherein the obtaining webpage data of a target webpage according to the target URL, comprises:
obtaining, from a user, its identity information registered on the first website;
according to the identity information and the target URL, determining whether the first object belongs to the user;
when the first object belongs to the user, according to the target URL, obtaining webpage data of a target webpage.

12. The method of claim 11, wherein the method further comprises:
when the first object does not belong to the user, sending a first prompt message to the user, the first prompt message indicating that the first object does not belong to the user.

13. The method of claim 11, wherein according to the identity information and the target URL, the determining whether the first object belongs to the user comprises:
according to the identity information, obtaining a URL of at least one object belonging to the user on the first website;
if the target URL is present in the URL of the at least one object, determining that the first object belongs to the user;
if the target URL is not present in the URL of the at least one object, determining that the first object does not belong to the user.

14. The method of claim 1, further comprising:
based on the publication information, publishing the first object on the second website.

15. The method of claim 14, wherein, based on the publication information, publishing the first object on the second website; and further comprises:
receiving a publication request from the user for modified publication information, and publishing the first object on the second website according to the modified publication information;
wherein, the modified publication information is obtained by the user modifying the publication information.

16. An information display method, comprising:
displaying a first input box and a second input box;
receiving a target URL of a first object on a first website, input in the first input box, and a user's identity information registered on the first website, input in the second input box;
when the first object belongs to the user, displaying publication information required for publishing the first object on a second website, wherein the publication information is generated based on the object information of the first object, wherein the object information of the first object is determined based on a target webpage's webpage data, and the target webpage is a webpage identified by the target URL;
when the first object does not belong to the user, displaying a first prompt message, wherein the first prompt message is used for prompting that the first object does not belong to the user.

17. The method of claim 16, wherein displaying a first input box and a second input box comprises:
displaying a first interface, the first interface comprising the first input box;
in response to receiving the target URL input in the first input box, displaying a second interface, the second interface comprising the second input box.

18. An information processing system, comprising:
a terminal device, configured to send an information generation request to a server device, wherein the information generation request is used for requesting generation of publication information required for publishing a first object on a second website, and the first object is a published object on a first website;
a server device, configured to, in response to the information generation request, acquire object information of a first object, wherein the object information of the first object is from the first website; based on the object information of the first object, select, from second objects already published on the second website, a similar object that is similar to the first object; and based on a category to which the similar object belongs on the second website, determine a publication category to which the first object belongs on the second website.

19. The system of claim 18, wherein the server-side device is configured to, based on the publication category and the object information of the first object, generate on the second website the publication information required for publishing the first object.

20. The system of claim 19, wherein
the server-side device is further configured to, based on the publication information, publish the first object on the second website.
